(19) United States
(12) Patent Application Publication
(10) Pub. No.: US 2006/0210385 A1
(43) Pub. Date: Sep. 21, 2006

(54) Skid-steer attachment

(76) Inventor: Doug Cook, Upton, MA (US)

Correspondence Address: CESARI AND MCKENNA, LLP, 88 BLACK FALCON AVENUE, BOSTON, MA, 02210, US

(21) Appl. No.: 11/074,079

(22) Filed: Mar. 7, 2005

(51) Int. Cl. B66C 23/00

(52) U.S. Cl. 414/725

(57) ABSTRACT

An attachment enables a front end loader, such as a skid-steer loader, to lift, carry and dispense loads at an extended distance from the loader. The attachment includes an elongated “chute” which is adapted to carry various types of materials. A movable “ram” is fitted within the interior of the chute and may be adjustably positioned along the length of the chute. Material loaded into the chute is initially positioned in front of the ram, i.e., between the ram and the distal (open) end of the chute. Thereafter, the ram may be actuated so as to apply a force on the loaded material, thereby displacing the material toward the distal end of the chute until at least some of the material is dispensed from the chute. After forcing material off the chute in this manner, the ram may be moved back towards its original position so additional material can be loaded into the chute.

### FIELD OF THE INVENTION

The present invention relates generally to attachments for skid-steer loaders and other front end loaders, and more specifically to a novel attachment that is adapted to lift, carry and dispense loads at an extended distance from the loader.

### BACKGROUND OF THE INVENTION

Front end loaders are commonly used for moving and manipulating earth and other materials that are typically too heavy or time consuming to handle manually. A skid-steer loader is a well-known type of compact, highly maneuverable front end loader. In general, a front end loader includes a cab (or “body”) in which an operator sits and controls the loader. The operator not only steers the loader from within the cab, but also controls a pair of lift arms pivotally connected to the sides of the loader. To that end, the operator can selectively apply one or more hydraulic signals that are used to power the wheels and lift arms, as well as any auxiliary hydraulics attached to the loader.

The operator may manipulate the actions of an implement attached to the distal ends of the lift arms. In this context, an implement is any tool or instrument that may be attached to the lift arms, e.g., by an appropriate mounting plate or coupler situated at the ends of the arms. Many different types of implements are presently available and include, among other things, various buckets, rakes, brooms, augers, grinders, graders, backhoes, and so forth. The operator of a front end loader selects which type of implement to attach to the loader based on his or her particular job requirement.

It is often difficult, if not impossible, for a front end loader to manipulate materials in certain geographic areas using conventional loader implements. For example, an area may be inaccessible to the loader due to spatial restrictions, such as fences or other barrier constraints, surrounding the area. In these cases, the loader's implement may not be capable of extending into the desired area, or the shape or dimensions of the implement may prohibit access to the area. Other areas may be inaccessible to the loader due to their extreme environments, e.g., due to their extreme heat, corrosive chemicals, etc.

By way of example, consider an outdoor furnace or stove, such as the Classic CL 5648 furnace available from Central Boiler® Incorporated. The furnace is constructed as a stand-alone shed having a relatively small, elevated front door that provides access to an internal chamber where fuel, such as wood or coal, is incinerated. Heat generated by the fuel combustion passes through the chamber walls to heat water that is circulated around the perimeter of the chamber. The resulting hot water may be used to heat an adjacent building.

In this example, the front door of the furnace is a relatively narrow opening that a front end loader cannot easily penetrate using conventional implements without likely damaging the door and/or the internal chamber of the furnace. Thus, fuel is usually loaded into such a furnace manually, e.g., by shoveling the fuel through the door and into the chamber. Manual loading of the fuel has obvious disadvantages, such as potentially causing muscular and/or skeletal injuries to the person who repetitively shovels the fuel into the furnace. Further, because the fuel must be loaded while the furnace is in operation, the extreme heat emanating from the furnace may prevent the person from distributing the fuel uniformly within the chamber. That is, most of the fuel shoveled into the chamber is usually situated close to the front door only a few feet or so within the internal chamber, thus resulting in uneven heat exchange in the chamber.

It is therefore desirable to adapt front end loaders so they may be used to lift, carry and dispense materials in areas that are presently inaccessible to the loaders due to physical or environmental constraints. For instance, in the case of conventional outdoor stoves or furnaces, the loaders should be able to safely access the depth of a relatively narrow fuel chamber while it is in use and provide a more uniform distribution of fuel within the chamber.

### SUMMARY OF THE INVENTION

The present invention provides a novel attachment that enables a front end loader, such as a skid-steer loader, to lift, carry and dispense loads at an extended distance from the loader. The attachment includes an elongated “chute” which is adapted to carry various types of materials, including but not limited to granular, chipped, cut or bundled materials. A movable “ram” is fitted within the interior of the chute and may be adjustably positioned along the length of the chute. Material loaded into the chute is initially positioned in front of the ram, i.e., between the ram and the distal (open) end of the chute. Thereafter, the ram may be actuated so as to apply a force on the loaded material, thereby displacing the material toward the distal end of the chute until at least some of the material is dispensed from the chute. After forcing material off the chute in this manner, the ram may be moved back towards its original position so additional material can be loaded into the chute. The novel chute and ram assembly can be constructed using various dimensions and geometries that enable the loader to lift, carry and dispense materials in locations that were previously inaccessible or otherwise unreachable using conventional loader implements.

In an illustrative embodiment, the ram is connected to an extendable linkage that may be extended and retracted by a double-acting hydraulic actuator. The hydraulic actuator is controlled by the operator of the loader. Specifically, the operator powers the hydraulic actuator by supplying an auxiliary hydraulic pressure from the loader. In response to the supplied pressure, the actuator applies a force on the linkage which, in turn, extends or retracts so as to displace the ram within the chute.

The novel attachment is preferably connected to the front end loader using a conventional coupling apparatus. Once attached, an operator may manipulate the loader's wheels and lift arms in order to “scoop” material into the chute of the attachment. Alternatively, material may be manually loaded into the chute. The cross-sectional shape of the chute may be tailored to fit within relatively small openings having various shapes and sizes. Thus, the chute may be used to deposit fuel into a relatively narrow opening of a stove or furnace. The novel attachment may be constructed using materials designed to operate in extreme chemical and/or thermal environments. For instance, in the case of a stove or furnace, the attachment may be constructed of a heat-resistant material. Advantageously, the attachment may be attached to various types of construction and agricultural equipment that are adapted to operate as front-end loaders.

### BRIEF DESCRIPTION OF THE DRAWINGS

The above and further advantages of the invention may be better understood by referring to the following description in conjunction with the accompanying drawings in which like reference numerals indicate identically or functionally similar elements, of which:

FIG. 1 is a side view of a front end loader that is adapted to lift and carry a load using an illustrative embodiment of the novel attachment of the present invention;

FIG. 2 is a side view of the front end loader of FIG. 1 after the load has been dispensed from the attachment in accordance with the illustrative embodiment;

FIG. 3 is a perspective view of the novel attachment shown in FIG. 1;

FIG. 4A is a partial side view of an illustrative embodiment of the novel attachment; and

FIG. 4B is a partial top view of the illustrative embodiment shown in FIG. 4A.

### DETAILED DESCRIPTION OF ILLUSTRATIVE EMBODIMENTS

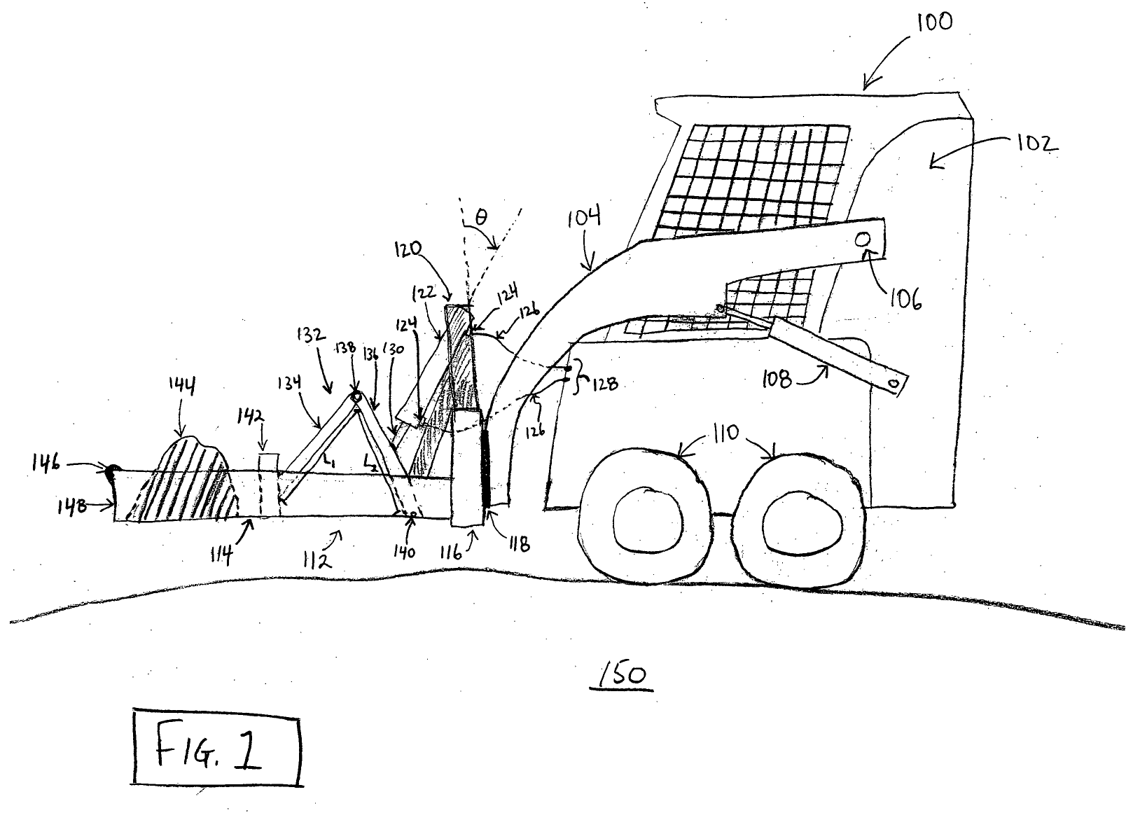

FIG. 1 illustrates an illustrative attachment 112 attached to a front end loader 100. The loader comprises a cab portion 102 in which an operator controls the operations of the loader. From within the cab, the operator may supply hydraulic pressure to actuate the wheels 110 and raise and lower the loader's lift arms 104. The operator may selectively actuate the wheels individually or in pairs, i.e., in the forward or reverse directions, to steer the loader around a work site 150. The lift arms 104 are pivotally connected to the sides of the cab 102 by hinge bolts 106. The bottom of each lift arm is connected to a respective rod 108 which telescopes from a double-acting hydraulic actuator 109 that is pivotally connected to the side of the cab 102. Accordingly, the operator can raise or lower the lift arms by supplying hydraulic pressure to the actuators 109, thereby extending or retracting their rods 108. The operator also may supply one or more auxiliary hydraulic pressures or electrical signals to control the operations of the attachment 112.

The distal ends of the lift arms 104 are bridged by a conventional mounting plate 118 which is adapted to attach to various types of loader implements and attachments. The attachment 112 includes a base portion 116 which engages the mounting plate 118, preferably using an industry standard coupling plate. The attachment 112 also includes an elongated “chute” portion 114 adapted to carry a load 144 which can be dispensed from the chute by a movable “ram” 142 fitted within the chute. The load may include various types of materials, including but not limited to granular, chipped, cut or bundled materials.

In operation, the load 144 is positioned in front of the ram 142, i.e., between the ram and the chute's distal end 148. The load may be manually loaded into the chute 114, or the operator of the loader may manipulate the loader's wheels 110 and lift arms 104 to essentially drive the attachment 112 into an external source of material and thus “scoop” the material from the source into the chute 114. Once the chute is loaded, the operator may lift and/or transport the loaded material to a desired location.

The length of the chute 114 may be selected based on the weight of the load 144 (and the weight of the attachment 112) to ensure that the load cannot destabilize the front end loader 100. Illustratively, the chute 114 may extend approximately 6 feet from the base portion 116 in order to lift, carry and dispense loads of approximately 500 pounds or less. A protective bulb 146 may be positioned (or welded) over at least one of the corners at the distal end of the chute 114. The bulb protects the corners of the chute from puncturing or damaging surrounding materials. For example, the bulb 146 may protect the exterior and interior of an outdoor furnace from inadvertent contact with the distal end of the chute. The bulb 146 may be composed of various materials, such as steel, rubber, plastic, etc. and may be formed in a variety of different shapes and sizes suitable for the environment in which the attachment 112 is deployed.

The movable ram 142 is actuated within the interior of the chute 114 by straightening or contracting a linkage 132. The linkage comprises a distal segment 134 that is pivotally connected at one end to a surface of the ram and is pivotally connected at its other end to a proximal segment 136 by a hinge 138. The other end of the segment 136 is pivotally connected, e.g., by a hinge bolt 140, to a fixed location at the bottom of the chute 114 or on the base portion 116. The lengths L₁ and L₂ of the distal and proximal segments are preferably set equal to each other to maximize the range of extension of the linkage, although it is also contemplated that other embodiments may select unequal lengths for L₁ and L₂. However, the sum of L₁ and L₂ should be selected so that the ram 142 cannot be displaced beyond the open end 148 of the chute 114.

The linkage 132 is straightened or contracted in response to a force applied to its proximal segment 136. Illustratively, a double-acting hydraulic actuator 122 is mounted above the proximal segment and applies a force on the segment 136 using an extendable rod 130. The actuator 122 is mounted at an angle θ which is selected so that the rod 130 can apply a sufficient force on the proximal segment as to displace the ram 142 a desired distance toward or away from the chute's distal end 148. The hydraulic actuator is preferably mounted within a support structure 120 that attaches to the top of the base portion 116 and to the sides of the chute 114.

The operator of the front end loader 100 controls the action of the hydraulic actuator 122 by supplying a hydraulic pressure through the loader's auxiliary ports 128. The hydraulic pressure is transmitted through the hoses 126 to respective inlets 124 on the actuator 122. By controlling the pressure from the auxiliary ports 128, the operator can extend or retract the rod 130 a desired amount. In this manner, the action of the rod 130 causes the linkage 132 to expand or contract, thus displacing the ram 142 within the chute 114.

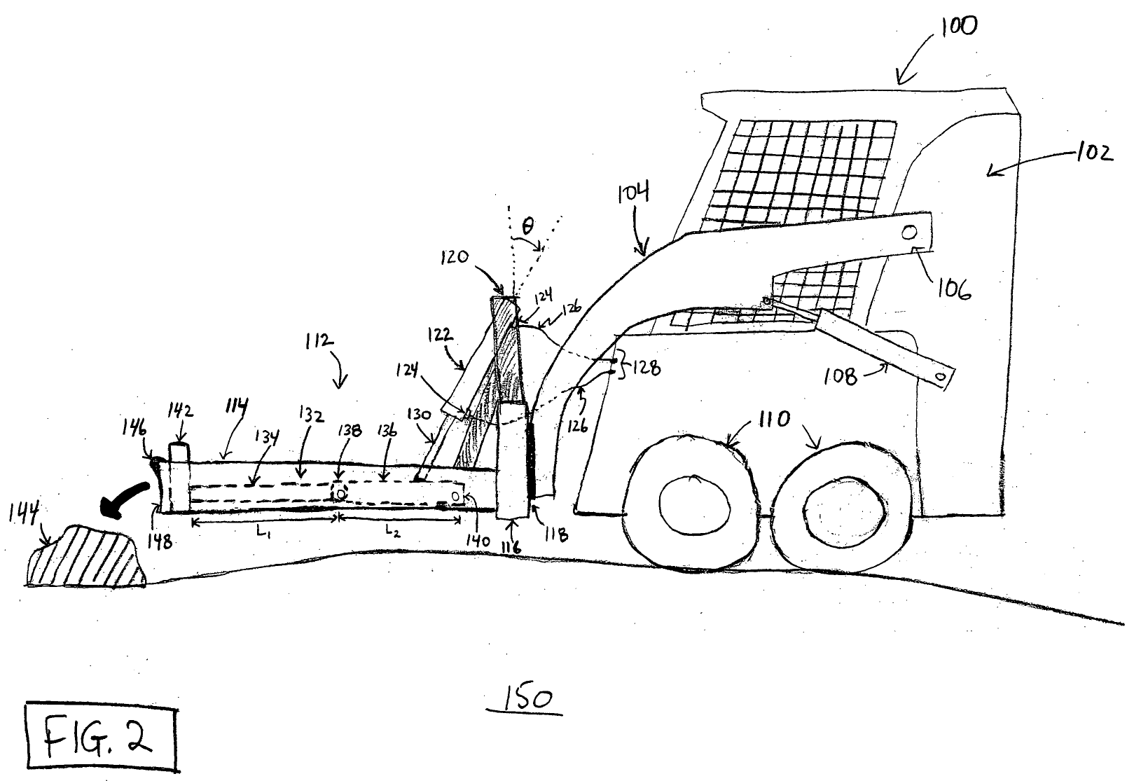

FIG. 2 illustrates the illustrative attachment 112 after the load 144 has been dispensed from the chute 114. Here, the linkage 132 is fully extended (i.e., to a length equal to L₁+L₂) by the rod 130, and the ram 142 is positioned at its furthest point from the base portion 116. By way of example, consider the situation where the loader operator transports and elevates the attachment 112 and positions the chute 114 through the front door of an outdoor furnace, such as the Classic CL 5648 model furnace available from Central Boiler® Incorporated. The ram 142 is actuated so as to dispense the load 144 within the internal chamber of the furnace. In this embodiment, the operator may slowly back up the front end loader from the furnace as the ram expels material into the chamber. As such, a more uniform distribution of fuel, such as wood or coal, may be deposited within the furnace as compared with manual shoveling techniques.

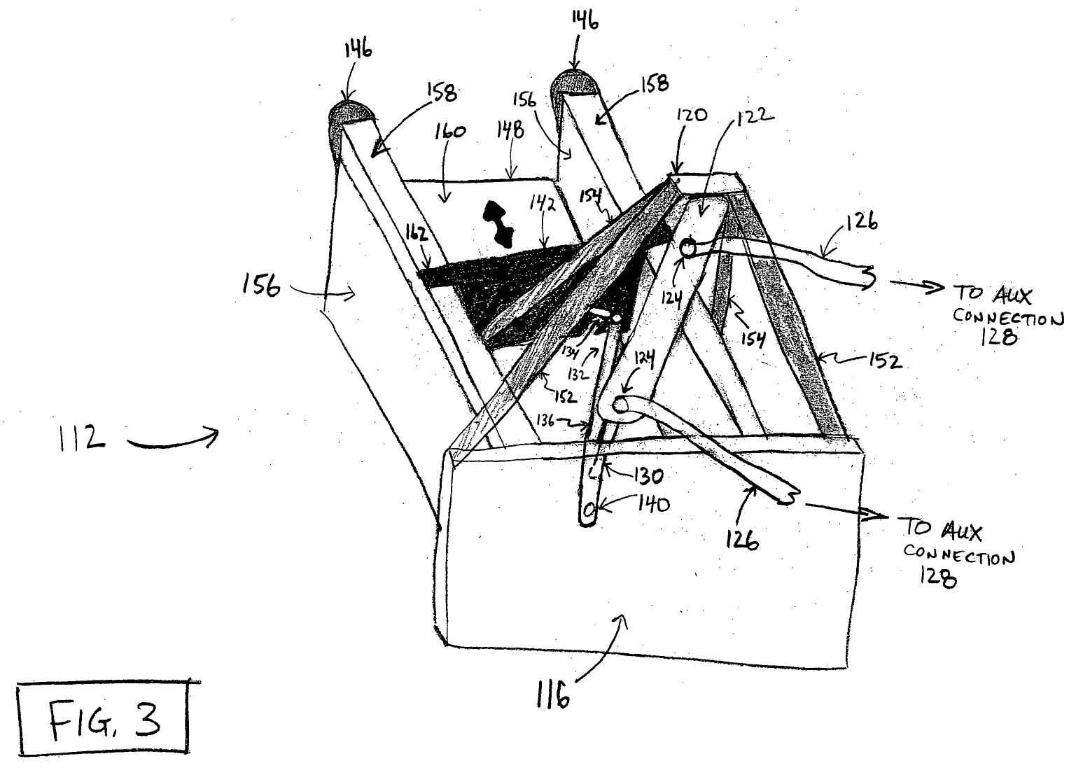

FIG. 3 illustrates a perspective view of the illustrative loader attachment 112. For clarity of illustration, the industry standard coupling mechanism used for attaching the base portion 116 to the loader's mounting plate 118 is not shown. The base portion 116 is attached to a chute portion 114 having a generally U-shaped cross section. The ram 142, linkage 132 and hydraulic actuator 122 are positioned within the interior of the U-shaped cross section. The ram is preferably shaped to fit snugly in the U-shaped chute, such that the perimeter surfaces of the ram make contact with, or nearly make contact with, the chute's bottom and side surfaces.

Preferably, the chute 114 is constructed from a single sheet of low-carbon (“mild”) steel, such as A36 steel. The sheet is bent into a U-shaped chute 114 having two substantially vertical side surfaces 156 and a flat (unbent) bottom surface 160. Of course, those skilled in the art will appreciate that the sheet may be shaped having various shapes and dimensions and may consist of other materials besides mild steel described in the illustrative embodiment. Further, the chute 114 may be formed using other functionally equivalent techniques, such as welding three separate sheets of material into a generally U-shaped structure. The bottom surface 160 is preferably planar, although it is also contemplated that it may be constructed having some curvature to facilitate carrying and dispensing loads 144 and for providing additional strength.

To strengthen the sides 156 and prevent them from splaying, a pair of right-angle supports 158 may be attached along their top surfaces. Illustratively, each angled support 158 is welded or otherwise secured to its respective side 156. The angled supports also provide flat rails on which flanges 162 connected to the ram 142 may slide as the ram is displaced within the chute. The top surfaces of the angled supports may be coated with a lubricant to reduce friction with the flanges 162.

The hydraulic-actuator support structure 120 is attached to both the base 116 and chute 114. The support structure 120 includes a pair of base supports 152 that connect to the top of the base portion 116 and a pair of side supports 154 that connect to the top of the side surfaces 156 or to the angle supports 158. The support structure 120 is shaped so that the double-acting hydraulic actuator 122 may be secured within the structure. Although not shown, additional restraints, such as belts or harnesses, may be used in place of, or in addition to, the support structure 120.

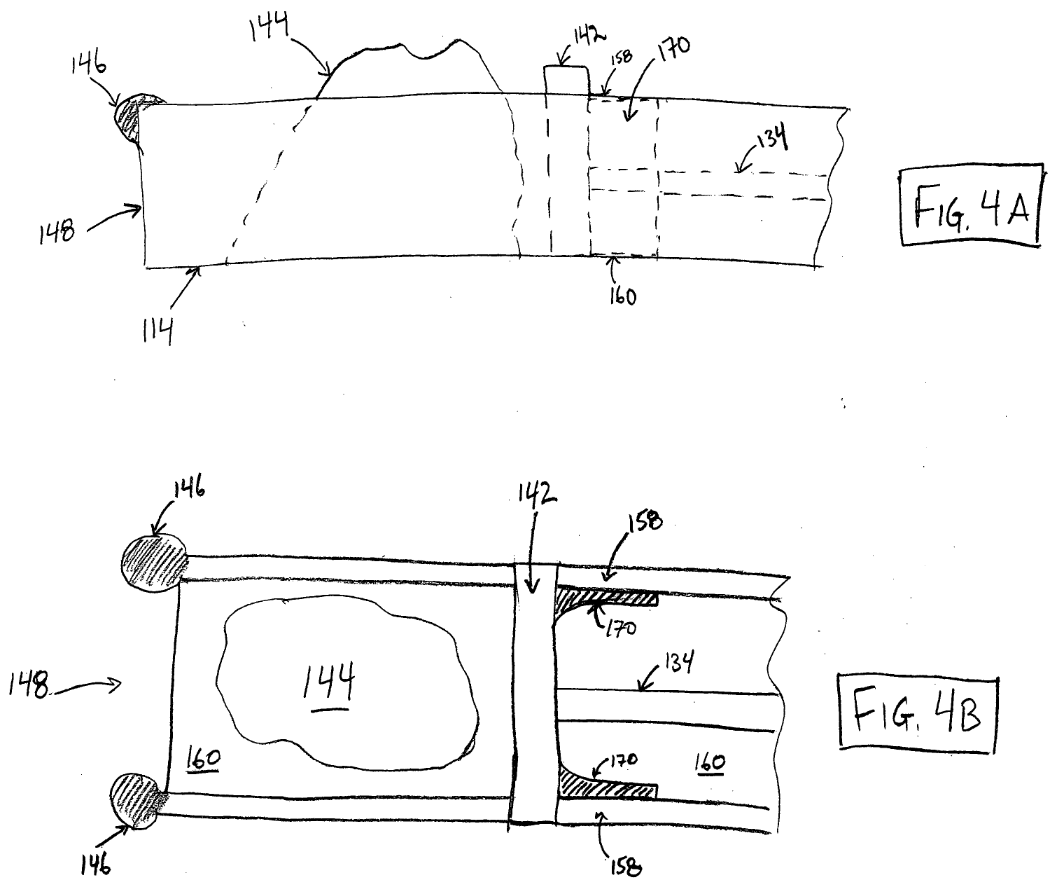

FIGS. 4A-B illustrate an illustrative embodiment of the attachment 112 in which a pair of gussets 170 provide additional stability to the ram 142. As shown, the gussets are attached to the back side of the ram and are shaped to fit between the angled supports 158 and the bottom surface 160 of the chute 114. Although the illustrated gussets are positioned along the sides 156, other types of supports alternatively may be attached to the ram 142. For instance, other embodiments may attach one or more supports to either the front and/or back surfaces of the ram, and the supports may be shaped differently than the illustrated gussets 170.

The foregoing is a detailed description of an illustrative embodiment of the invention. Various modifications and additions can be made without departing from the spirit and scope of the invention. For example, while the chute portion 114 is described herein as having a generally U-shaped cross section, those skilled in the art will understand that other cross-sectional shapes may be equivalently used. For instance, the bottom surface 160 of the chute 114 may assume a curvilinear contour, e.g., to facilitate carrying and lifting of certain materials. In addition, some embodiments may perforate at least a portion of the bottom surface 160 of the chute, e.g., close to the distal end 148, to more uniformly dispense material 144 from the chute. Further, the distal end of the chute may be “closed” or blocked whereby material is dispensed from a hole strategically placed in the bottom surface 160 of the chute.

Although the attachment 112 is illustratively described for loading fuel into a stove or furnace, those skilled in the art will appreciate that the advantages of the attachment may be realized in other settings. For example, the attachment may be used to dispense material into a region of a dumpster or other container that was previously unreachable using conventional loader implements.

It is also expressly contemplated that functionally equivalent elements and structures may be used in place of those described in the illustrative embodiment of the attachment 112. For example, the linkage 132 may be embodied as a non-hinged (i.e., linear) segment that is actuated to displace the ram 142 within the chute 114. Alternatively, the linkage 132 may contain more than two hinged segments. Various types of hinging mechanisms known in the art may be used to provide the pivotable connections described herein. The double-acting hydraulic actuator 122 may be embodied as a hydraulic cylinder or any other hydraulic actuator that functions consistently with the illustrative embodiments. Further, a variety of different materials may be used to construct the attachment 112, depending on the environment in which it will be used. For instance, rather than using steel, the attachment may be constructed using other materials designed to operate in extreme chemical and/or thermal environments.

Accordingly, this description is meant to be taken only by way of example and not to otherwise limit the scope of the invention.

What is claimed is:

1. An attachment that enables a front end loader to lift, carry and dispense loads at an extended distance from the loader, the attachment comprising:
a chute portion adapted to carry a load; and
a ram mounted within the chute portion, the ram being adapted to move within the chute portion so as to dispense at least a portion of the load from the chute portion.

2. The attachment of claim 1, further comprising:
a base portion connected to the chute portion, the base portion having a coupling mechanism that attaches the attachment to the front end loader.

3. The attachment of claim 1, further comprising:
a hydraulic actuator adapted to apply a force on a linkage connected to the ram, the applied force extending or retracting the linkage so as to displace the ram within the chute portion.

4. The attachment of claim 3, wherein the hydraulic actuator is actuated in response to an auxiliary hydraulic pressure supplied from the front end loader.

5. The attachment of claim 1, wherein the hydraulic actuator is a double-acting hydraulic cylinder.

6. The attachment of claim 3, further comprising:
a support structure adapted to secure the hydraulic actuator.

7. The attachment of claim 3, wherein the linkage comprises a plurality of pivotally connected segments between the ram and the hydraulic actuator.

8. The attachment of claim 7, wherein the linkage further comprises:
a first segment having first and second ends, the first end of the first segment being pivotally connected to the ram; and
a second segment having first and second ends, the first end of the second segment being pivotally connected to the second end of the first segment, and the second end of the second segment being pivotally connected to a fixed location on the attachment.

9. The attachment of claim 8, wherein the first and second segments are the same length.

10. The attachment of claim 1, wherein the chute portion has a generally U-shaped cross section.

11. The attachment of claim 10, wherein the chute portion is constructed from a single sheet of material that is bent into the generally U-shaped cross section.

12. The attachment of claim 10, wherein the sides of the generally U-shaped cross section are covered with angled supports.

13. The attachment of claim 1, wherein the chute portion has a perforated region.

14. The attachment of claim 1, wherein the chute portion has a strategically placed hole for dispensing the load.

15. The attachment of claim 1, wherein the load includes at least one of a granular, chipped, cut or bundled material.

16. The attachment of claim 1, wherein the front end loader is a skid steer loader.

17. A method for transporting and dispensing a load using a front end loader, the method comprising:
attaching an attachment to the front end loader, the attachment having a chute portion adapted to carry the load and a ram adapted to dispense the load from the chute portion;
placing the load in the chute portion, the load being situated between the ram and a distal end of the chute portion;
transporting the load to a desired location; and
displacing the ram towards the distal end of the chute portion, thereby forcing at least a portion of the load off the chute portion and into the desired location.

18. The method of claim 17, further comprising:
displacing the ram away from the distal end of the chute portion after dispensing at least a portion of the load into the desired location.

19. The method of claim 17, wherein the step of displacing the ram further comprises:
connecting a linkage between the ram and a hydraulic actuator; and
actuating the hydraulic actuator so as to apply a force on the linkage, thereby displacing the ram in a selected direction in the chute portion.

20. A front end loader and attachment assembly for transporting and dispensing a load at an extended distance from the loader, the assembly comprising:
means for attaching an attachment to the front end loader, the attachment having a chute portion adapted to carry the load and a ram adapted to dispense the load from the chute portion;
means for placing the load in the chute portion, the load being situated between the ram and a distal end of the chute portion;
means for transporting the load to a desired location; and
means for displacing the ram towards the distal end of the chute portion, thereby forcing at least a portion of the load off the chute portion and into the desired location.

21. The assembly of claim 20, further comprising:
means for displacing the ram away from the distal end of the chute portion after dispensing at least a portion of the load into the desired location.

22. The assembly of claim 20, wherein the means for displacing the ram further comprises:
means for connecting a linkage between the ram and a hydraulic actuator; and
means for actuating the hydraulic actuator so as to apply a force on the linkage, thereby displacing the ram in a selected direction in the chute portion.
